(19) United States
(12) Patent Application Publication
(10) Pub. No.: US 2007/0288376 A1
(43) Pub. Date: Dec. 13, 2007

(54) Emergency costs tracking and reporting apparatus and method

(76) Inventor: Roy W. Block, Orlando, FL (US)

Correspondence Address: BAKER, DONELSON, BEARMAN, CALDWELL & BERKOWITZ, SIX CONCOURSE PARKWAY, SUITE 3100, ATLANTA, GA, 30328, US

(21) Appl. No.: 11/448,526

(22) Filed: Jun. 7, 2006

(51) Int. Cl. G06Q 40/00

(52) U.S. Cl. 705/44

(57) ABSTRACT

Computerized tracking, analysis, and reporting of emergency recovery costs and disbursements of payment funds using an information database of applicants for emergency recovery funds to be applied in payment of recovery costs, each of the applicants having at least one project for recovery from an emergency and for which a payment of at least one recovery cost is selectively funded from a supply of emergency recovery funds, in which an application interface provides recovery cost information based on at least one support document reflecting a recovery cost for reimbursement associated with the project, and an analyzer configured for evaluating submitted recovery costs and support documents and determining a payment authorization factor, with a payment center for funding payment of the recovery costs based on the payment authorization factor.

### TECHNICAL FIELD

The present invention relates to apparatus and methods for analyzing financial information associated with emergency recovery efforts. More particularly, the present invention relates to real time review and analysis of emergency recovery costs and the supporting documentation for reimbursement of these costs and selective disbursement of funds in payment of the emergency recovery costs.

### BACKGROUND OF THE INVENTION

Natural occurring events such as large storms including hurricanes, typhoons, and the like, fires, floods, and other such events, often have a devastating effect on large geographical areas. Naturally occurring events coupled with infrastructure failures often lead to destruction and loss of improved property including homes, apartments, office buildings, businesses, government facilities and infrastructure, farm facilities, and other similar land use improvements. Further, wide spread geographical natural events may lead to injuries and loss of life.

Governmental agencies often respond to wide area emergency events with suitable declarations of emergency. These declarations provide for extraordinary government activities in order to respond to the emergency, including government, non-profit, and public entities. Various federal, state, and local agencies are tasked with emergency response activities including safety, rescue, recovery, clean-up, and reconstruction. Declarations of emergencies by Federal authorities typically are presently handled through the Federal Emergency Management Agency (FEMA), although other agencies may be involved. This agency and others, including state agencies that also provide oversight and funding, are responsible for managing recovery activities. FEMA works with the applicable state agencies, also referred to “grantees”, to fund requests for reimbursement from applicants. Applicants are also referred to as “sub-grantees”, and these applicants include the eligible public and not-for-profit agencies. The sub-grantees engage in projects for reconstruction efforts in response to the destruction caused by the emergency. The sub-grantees seek reimbursement for reconstruction costs from a number of sources, but FEMA often functions as a reimburser of final resort. Reimbursable expenses must be requested and must be documented. Further, due to the often hectic nature of emergency response and reconstruction efforts, oversight agencies are faced with having to review and disperse funds in a dynamic, changing and confusing work environment.

Generally, the applicants for reimbursement of costs and the cost expenses must be qualified in order to receive federal reconstruction finding and reimbursement. The applicant must be eligible under appropriate funding provisions, and particularly located within a political subdivision included in the geographic area deemed to be under emergency conditions. The applicant must identify the project requiring funding and thereby quantify the damage for which reconstruction funding is sought. The applicant must procure contracts and appropriate support documents relative to the project. All other funding available to the applicant must be exhausted prior to disbursement of Federal funds. These other funding sources include, for example, insurance coverage, other grants, and available internal funds.

Notwithstanding that an applicant submits an application for reimbursement of reconstruction costs and a disbursement of funds is made, the funding process is subject to audit. Typically, the funding agency has up to three years to audit after the last project is completed for a sub-grantee which may be 8 to 10 years, or more, after the event has taken place.

One result of an audit may be a requirement that previously reimbursed costs be rejected. Thus, the recipient of the reimbursement must re-pay those funds to the government. As may be expected, this leads to disputes over the type of documentation required to support reimbursements, interpretation of agency reimbursement requirements, and the inability of sub-grantees to reproduce or to provide supporting documentation for costs years after the event occurred and after the costs were incurred for reconstruction.

Further, the gathering, review and disbursement process has not been readily accessible to grantees, sub-grantees, and other interested parties, for review of the status of submitted reimbursable costs of projects and for potential issues of reimbursement from the view point of the funding agency. Accordingly, sub-grantees are often in the difficult position of incurring reconstruction costs prior to having specific direction as to documentation required for obtaining these funds and for avoiding subsequent “deobligations” or required repayment of reimbursed costs.

Particularly, the funding agencies that have to comply with state and federal reimbursement guidelines are handling extremely high volumes of paper and information while attempting to maintain financial compliance to reimbursement policies and regulations. Often it is difficult to know without careful study the quality of the request for reimbursement and the supporting documentation entitling reimbursement to the sub-grantee. The funding agency faces the question of funding projects with questionable support while the sub-grantee faces delays and completion problems in attempting to comply with documenting the reimbursement requests pursuant to appropriate agency regulations and policies. The process has limited transparency in that documents are submitted but the sub-grantees are unable to realistically obtain status information of the requests. Audits often must occur in the sub-grantee locations for review documents. Because audits often occur many years after the close of the project for which reimbursement was sought, documents may no longer exist or may not be obtainable to support properly the requested reimbursement.

Accordingly, there is a need in the art for an improved apparatus and method for real time tracking and analysis and reporting of emergency recovery costs and disbursement of funds in payment of those costs. It is to such that the present invention is directed.

### SUMMARY

The present invention meets the needs in the art for an improved real time review and analysis apparatus for tracking and reporting of emergency recovery costs and disbursements of funds in payment thereof, comprising a central computer having a database of a plurality of applicants for emergency recovery funds to be applied in payment of recovery costs, each of the applicants having at least one project for recovery from an emergency and for which a payment of recovery costs is selectively funded from a supply of emergency recovery funds. Each of the applicants applies for payment of recovery costs associated with at least one project. The central computer receives and stores for analysis access at least one submitted document reflecting a recovery cost submitted for payment and at least one support document justifying funding of payment of the recovery cost. An analyzer configured for evaluating submitted recovery costs and support documents determines a payment authorization factor. A payment center funds payment of the recovery cost based on the payment authorization factor.

In another aspect, the present invention provides a method for tracking and reporting of emergency recovery costs and disbursements of funds in payment thereof, comprising the steps of:

(a) providing to a database of a central computer information as to a plurality of applicants for emergency recovery funds to be applied in payment of recovery costs, each of the applicants having at least one project for recovery from an emergency and for which a payment of recovery costs is selectively funded from a supply of emergency recovery funds;

(b) identifying at least one project associated with at least one of the applicants seeking payment of recovery costs associated with at the project;

(c) receiving and storing for analysis access at least one submitted document reflecting a recovery cost submitted for payment and at least one support document justifying funding of payment of the recovery cost;

(d) analyzing the submitted recovery costs and the support documents to determine a payment authorization factor; and

(e) selectively finding payment of the recovery cost based on the payment authorization factor.

Objects, advantages, and features of the present invention will become readily apparent upon a reading of the following detailed description in reference to the drawings and the appended claims.

### BRIEF DESCRIPTION OF THE DRAWINGS

FIG. 1 illustrates in schematic view an emergency recovery funds tracking and reporting apparatus according to the present invention.

FIG. 2 illustrates the method of emergency recovery funds tracking and reporting according to the present invention.

FIG. 3 illustrates a data screen for team contact information about persons engaged in the emergency recovery funds tracking and reporting apparatus and method.

FIG. 3A illustrates the data screen shown in FIG. 3, with data and filtering for searching and sorting of the information in the funds tracking and reporting system.

FIG. 4 illustrates a data entry screen for sub-grantees applying for reimbursement of emergency recovery costs through the emergency recovery funds tracking and reporting apparatus.

FIG. 5 illustrates a contacts information screen for the primary contact and alternate contact for the sub-grantee.

FIG. 6 illustrates a data screen for recording information about correspondence related to the application for reimbursement of emergency recovery costs by the sub-grantee.

FIG. 7 illustrates a data screen for recording information about meeting related to the application for reimbursement of emergency recovery costs by the sub-grantee.

FIG. 8 illustrates a data screen for sub-grantee invoice information related to the application for reimbursement of emergency recovery costs by the sub-grantee.

FIG. 9 illustrates a data screen for documenting force labor (tested) related to the application for reimbursement of emergency recovery costs by the sub-grantee.

FIG. 10 illustrates a data screen for documenting force applied equipment (tested) related to the application for reimbursement of emergency recovery costs by the sub-grantee.

FIG. 11 illustrates a data screen for documenting rental equipment (tested) related to the application for reimbursement of emergency recovery costs by the sub-grantee.

FIG. 12 illustrates a data screen for documenting materials (tested) related to the application for reimbursement of emergency recovery costs by the sub-grantee.

FIG. 13 illustrates a data screen for documenting contract services (tested) related to the application for reimbursement of emergency recovery costs by the sub-grantee.

FIG. 14 illustrates a close-out screen for a small projects application for reimbursement of emergency recovery costs by the sub-grantee.

FIG. 15 illustrates a control screen for selectively accessing data screens and report screens.

### DETAILED DESCRIPTION

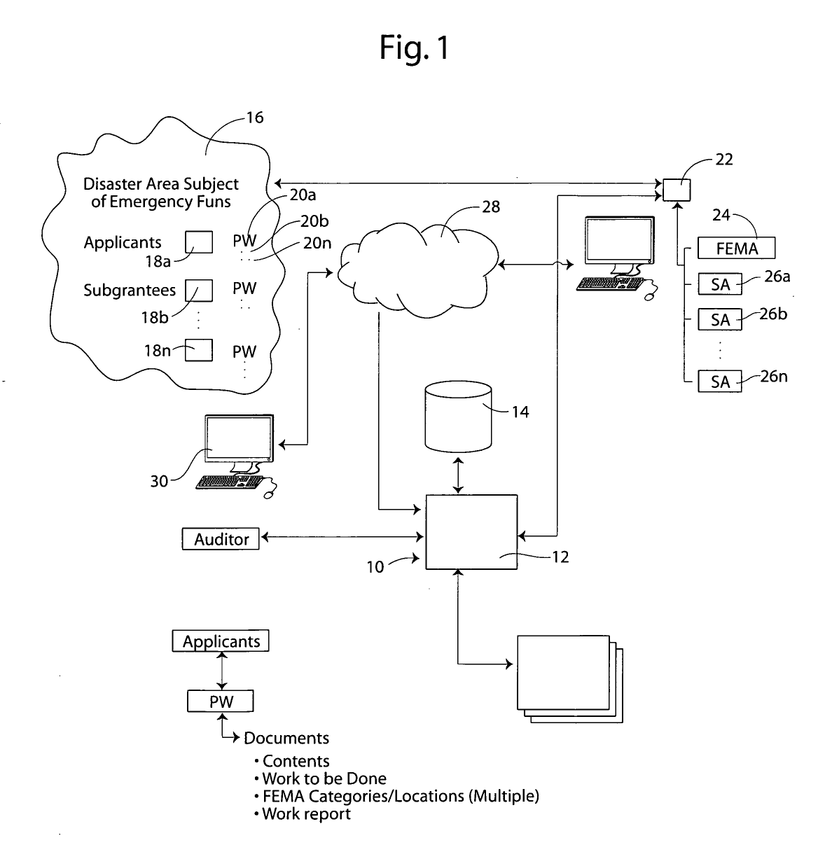

Referring now in more detail to the drawings, in which like numerals indicate like parts throughout the several views, FIG. 1 illustrates in schematic view an emergency recovery funds tracking and reporting apparatus 10 according to the present invention. The apparatus 10 includes a central computer 12 with a microprocessor controller and a mass storage device 14 that maintains a database of information reported for financial oversight of emergency recovery events and of images of source documents submitted for reimbursement of costs. The emergency events are the one or more emergency or disasters declared in a particular geographic area having political subdivisions such as counties or states. For tracking and reporting purposes, each particular declared emergency or disaster is assigned a unique identifier. There are one or more applicants or sub-grantees 18. Each applicant 18 has at least one work project for which emergency recovery funds are sought from a funding source generally 22. The funding source includes federal agencies such as FEMA 24 and one or more state agencies generally 26 within the geographic area of the particular emergency 16.

The computerized apparatus 10 includes communication -through a wide area network, generally 28, such as the world-wide-web. Other communications systems may be used, such as a direct connection or link of communications lines, or a closed local area or internal network connecting applicants 18, funding sources 22, and the computer 12 of the emergency recovery funds tracking and reporting apparatus 10. For example, each applicant can communicate with the system 10 through a conventional stand alone personal computer generally 30 or, by visiting a centralized support center staffed with skilled personnel involved in the emergency response and funding procedures. At such sites, the applicants provide information -to the tracking and reporting system 10 with assistance of system staff. Similarly, the funding sources 22 including the federal source 24 and state agencies 26 communicate through stand-alone personal computers interconnected to the computer 12 through the world-wide-web 28 or the other described communication systems.

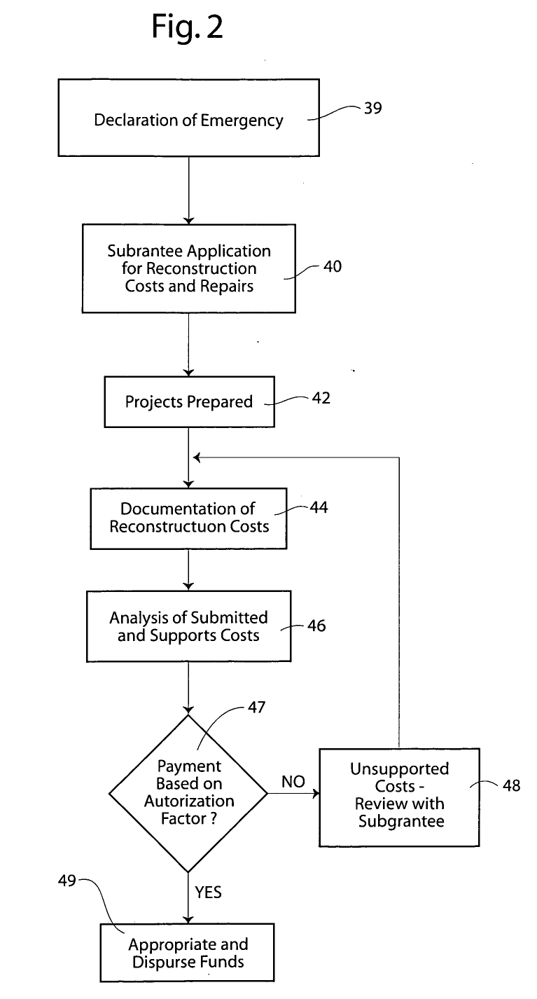

FIG. 2 illustrates the emergency funds tracking and reporting method according to the present invention. During an emergency, appropriate government agencies invoke emergency procedures 39. A sub-grantee 18 applies 40 for federal financial assistance. During the application process, information about the sub-grantee 18 is obtained. The particular project 20 for the sub-grantee 18 is identified 42. Subsequently, documentation of project costs are submitted and entered 44 into the tracking and reporting apparatus. As the particular project proceeds, additional documentation supporting the completion of work on the project is submitted. Periodically, or upon demand, analysis 46 can be performed using the financial data submitted by the sub-grantee 18. Further, the sub-grantee 18 can request reimbursements. For small projects, typically the sub-grantees request reimbursement at the completion of the project. Larger projects may have work-in-progress reimbursement.

The analyzer considers the requested reimbursement and the supporting documentation. The analyzer determines 47 a payment authorization factor discussed below based on the quality of the supporting documentation and information as to the recovery costs submitted for reimbursement. Unsupported costs or insufficiently supported costs can be discussed 48 with the sub-grantee seeking reimbursement. Responsive to these discussions, the sub-grantee can obtain and provide additional documentation for supporting requested reimbursements. Upon a satisfactory authorization factor, funds are appropriated and disbursed 49 for reimbursing recovery costs.

The grantee 26 may require appropriately certified documentation of some or all of the costs for which reimbursement is requested, or no documentation at all. Requiring such certified documentation is referred to as “testing”, in that all or a portion of the costs must be “tested” for correctness by the sub-grantee 18 providing appropriate invoices, contracts, time records, and the like authenticating documentation for the requested costs of the project for reimbursement. Thus, for example, the grantee may pay 100% of the submitted request for reimbursement based on a 20% testing rate. The system enables detailed interrogation as to the 20% of the costs, as discussed below. Further, the real time analysis and interactive access available through the system 10 by the sub-grantee enables a determination of the quality of the “tested” cost. In one aspect of the invention, a patentee may test a particular percentage, but deem acceptable for payment a threshold percentage of supported documentation. This supported threshold is less than a 100% testing of the portion of the cost to be tested. This aspect of the invention involves a determination of the quality of the tested costs, and if a satisfactory quality is reached, the payments are made. The testing percentage and the quality factor are determinations made by the grantee, and implemented by the administrator of the system 10.

The emergency recovery funds tracking and reporting system 10 provides an interactive accessible database containing information about personnel involved in the tracking and reporting system, the state agency or grantee personnel, sub-grantee as well as, information regarding correspondence, and meeting reports. The system receives invoice information from documents, such as invoices, related to recoverable reconstruction costs for projects associated with the sub-grantee.

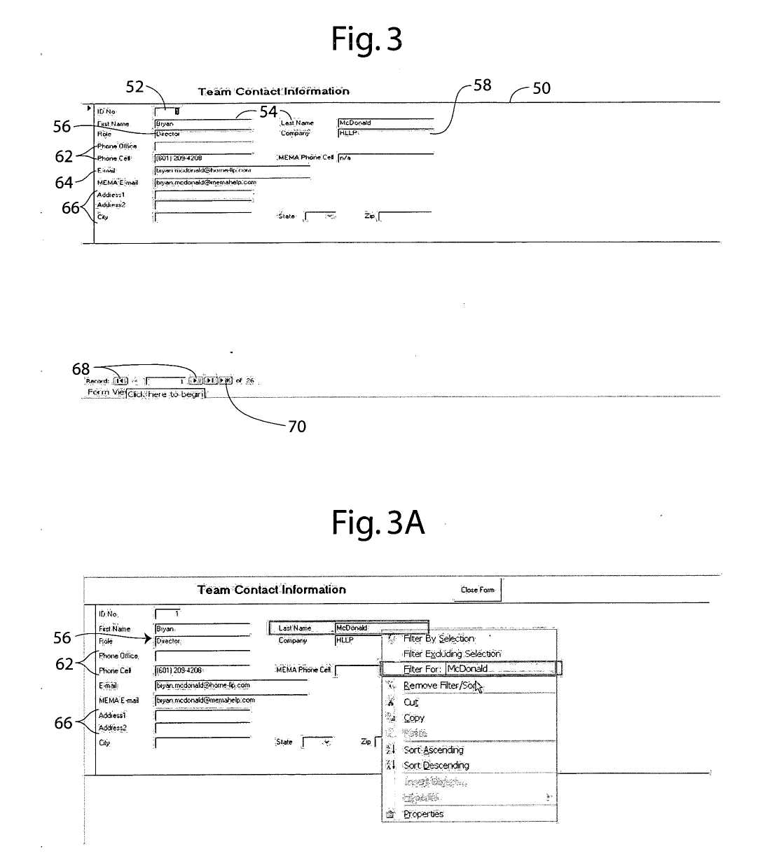

FIG. 3 illustrates a data screen 50 for system or team contact information related to the persons engaged in operation of the tracking and reporting system 10. The screen 50 includes an ID number 52, team member name 54, title or role 56, company name 58, as well as contact information including phone numbers 62, e-mail 64, and address 66. Forward and reverse buttons 68 indicated by directional arrows permit moving selectively through the database of team contact members. An add button 70 enables new team contact information to be entered for a particular individual. A close window button 71 operates to close the screen and return the display to a control screen for selection of other data entry, analysis, and reports, as discussed below. Other of the data information, analysis, and report screens discussed below include the buttons 68, 70, and 71, and are not otherwise discussed.

In addition, the team contact screen 50 can be used for searching for particular individuals. This is accomplished by positioning the cursor into the field to be searched, for example, entering a last name of a person in the name field 54 enables listing persons with that last name. An action list (see FIG. 3A) enables filtering by selection, filter by excluding selection, filter for a particular name, removing the filter, cut in order to delete the team contact member, copy information or transfer to another document or record, sort capability, and properties.

A data screen (not illustrated) similar to that in FIG. 3 provides for both entry of agency contact information, including federal, state and local agency personnel, and access to such information for searching and reports. The information is the same as for the team contact screen 50 shown in FIG. 3, and is not otherwise discussed. That screen is likewise configured for selective filtering and searching of the database.

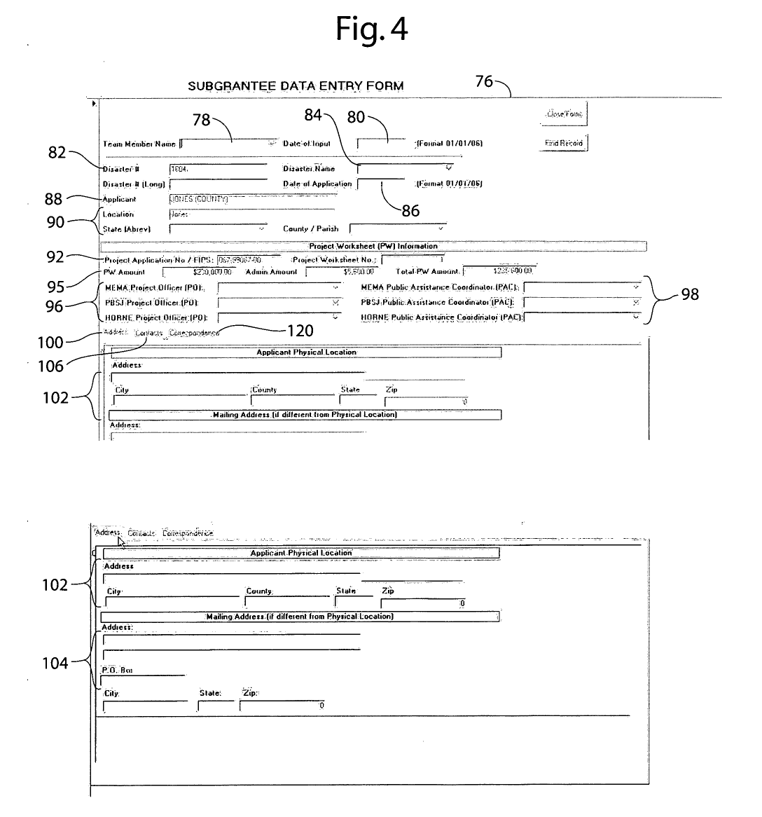

FIG. 4 illustrates an applicant or sub-grantee data entry screen 76. The screen 76 provides a field 78 for entry of the name of the team member entering the information and the date of input 80. The screen provides for disaster information including the assigned disaster number 82, name 84 of the team member, and the date 86 of the application by the sub-grantee. The screen includes the name of the applicant 88, its location 90, and address such as a street address, state, and county.

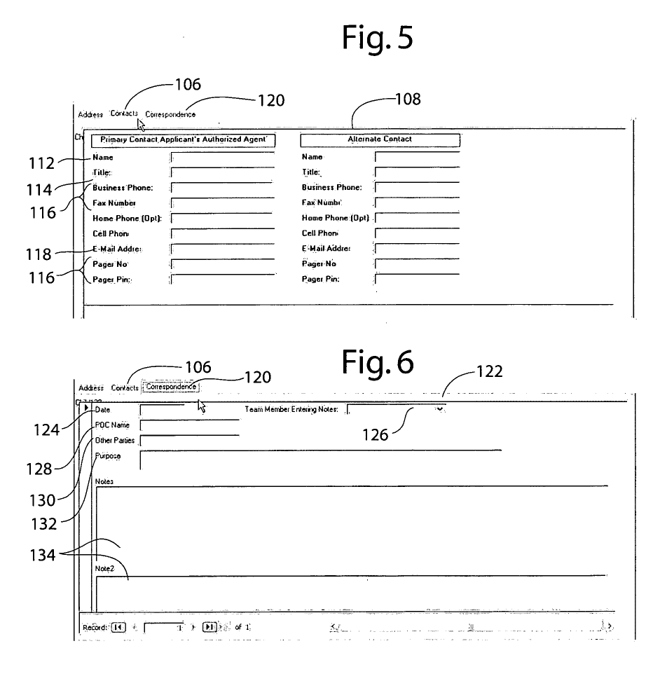

Each applicant seeks reimbursement for at least one project. The project worksheet information includes the project application number 92 and the project worksheet number 94. The project worksheet number is assigned sequentially by the system 10 upon initial entry of the project. The project amount 95 is entered including the reconstruction costs, administrative amount, and total project amount. Personnel associated with the project are identified including project officers 96 and assistance coordinators 98. An address button 100 activates a pop-up screen for providing the applicant address 102 and mailing address 104 if different from the physical location of the applicant. The contacts button 106 brings up a pop-up window 108 shown in FIG. 5. The contacts window includes the primary contact and alternate contact for the applicant. Appropriate identification information is entered for each, including name 112, title 114, phone information generally 116, and e-mail address 118. A correspondence button 120 brings up a correspondence window 122 illustrated in FIG. 6. The correspondence window includes a date field 124, a field for identifying the team member entering the correspondence notes 126, the addressee 128 and other persons 130, a description of the purpose 132, and notes 134.

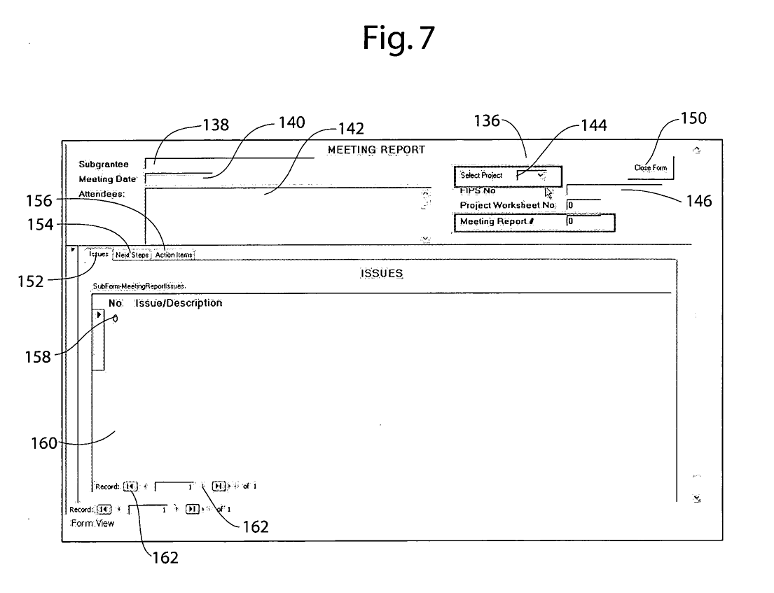

FIG. 7 illustrates a meeting report screen 136 for recording meetings, site visits, or communications with the sub-grantee. The meeting report screen 136 includes a field 138 for the sub-grantee involved, the meeting date 140 and attendees 142. A select project window 144 when activated brings up a list of projects for the particular sub-grantee. The FIPS number field 146 in project worksheet 148 can be entered or populated upon selection using the select project window 144. The meeting report number provides an incremental count of meetings with the sub-grantee on the particular work project. A close form button 150 closes the form 136 in returns control to a main menu screen. Each meeting report includes issues 152, next steps 154, and action items 156. Selecting any of the buttons 152, 154, 156 brings up a particular pop-up window for entering information as to pending issues, next steps, and action items to be accomplished. This may be considered as “to-do” items including identification of person(s) responsible for the issue or activity, relevant dates, status, and completion information. FIG. 7 illustrates an issues record permitting entry of an issue number 158 and a description field 160. Directional arrows generally 162 permit the user to page through the issues. A sequence display 164 provides a sequence number of the records. Similar pop-up windows are provided for the next steps and the action items. Although not illustrated, the action items window includes a completion field so that activities can be tracked.

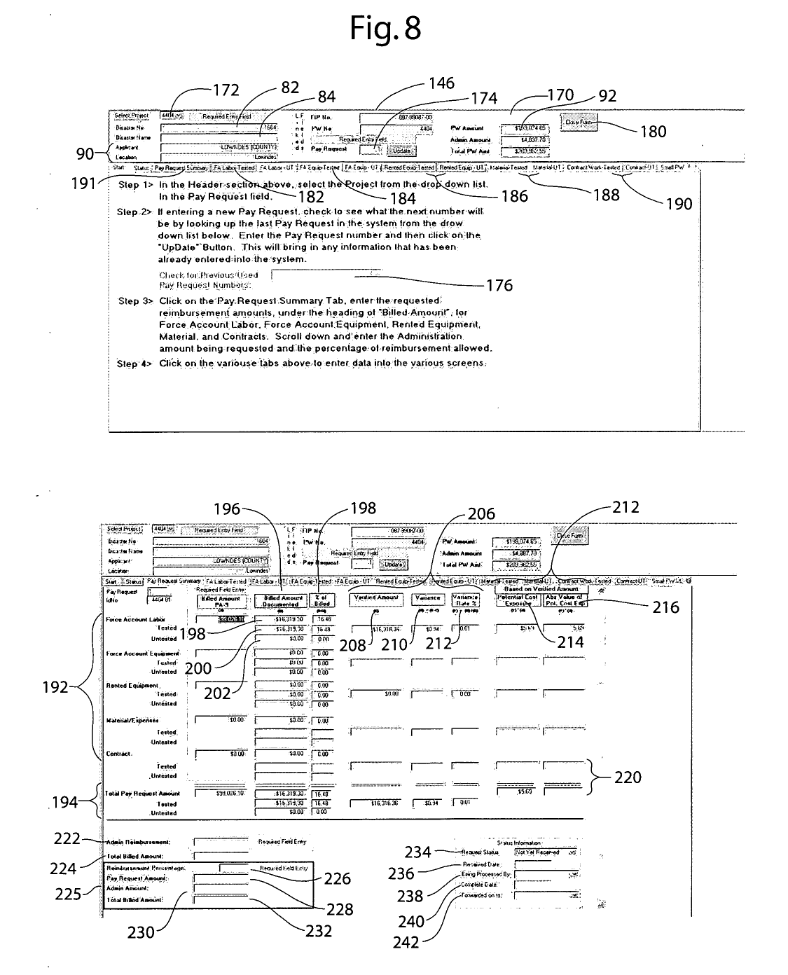

Associated with each project is one or more sub-grantee invoice information. FIG. 8 illustrates a sub-grantee invoice information data screen 170. Requests for reimbursement are entered with the data screen 170. The sub-grantee invoice screen 170 includes a field 172 for the project ID as well as the disaster number 82 and disaster name 84, the applicant 88 and the applicant's location 90, the FIPS number 146 and the project number 94. A pay request field 174 is used to enter the next pay request number in sequence. That information can be determined by using a check window 176 for previously used pay request numbers. The header of the screen 170 also includes the project amount, administrative amount, and total amount fields 92. The close form button 71 closes the screen and returns to a selection control window. The header field is interactive, in that positioning the cursor in one of the fields brings up a drop-down list of the various disasters, projects, or applicant. The sub-grantee invoice information screen shown in FIG. 8 includes selection buttons for categories of expenses (tested and untested) including force labor 182 (work performed by the subgrantee's own labor), force equipment 184 (work performed by the subgrantee's own equipment), rented equipment 186, material 188, and contract 190 (such as construction and professional services contracts), as well as pay request summary 191. A summary sheet or federal form provides quantified damage and reconstruction information for the particular subgrantee and project. Each project worksheet is associated with a specific location (address or GPS coordinates) and will have a scope of work, a narrative of the work, photographs, and a quantification of the damage, including a work breakdown, for example, by FEMA category. A small project may have only one request for reimbursement while large projects may have multiple reimbursement requests, each with supporting documentation.

The screen 170 also includes data fields generally 192 for entry of the reimbursement amounts requested by the applicant. Using the submitted reimbursement request document, the costs for force labor, force equipment, rented equipment, material expenses, and contract expenses are entered. A total 194 is computed and should be compared to the total pay request amount submitted by the applicant.

As discussed above, the system enables separating the requested reimbursement amount into tested and untested categories. Tested refers to the requirement by the grantee that appropriate and satisfactory documents be submitted to document the requested amount of reimbursement. The tested percentage can vary between 0 and 100 percent. FIG. 8 further shows a billed amount documented column 196 and a percent of the billed to be tested and untested 198. Each of the expense reimbursement categories is divided into a total amount 198, a tested amount 200, and an untested amount 202. Column totals 204 show the total requested amount and the break down as to tested and untested.

The screen 170 further shows variance analysis generally 206. A verified amount column 208 shows the amount of the expenses that are supported with verified documents justifying the requested payment. A variance column 210 reflects the difference between the requested amount of reimbursement and the verified amount. A variance rate 212 shows the percentage of the variance compared to the requested amount for reimbursement. A reimbursement risk generally 214 is computed. This includes the potential cost exposure generally 216 and the absolute value of the potential cost exposure 218. Column totals 220 reflect the variance analysis and risk of the variance between the requested reimbursement and the supported documented cost.

Administrative reimbursement costs 222 are entered. A total billed amount 224 is computed by adding the administrative reimbursement to the costs reimbursement requested 194. The reimbursement amount 226 is displayed. This includes the reimbursement percentage 226, the requested amount 228, the administrative amount 230 and a total amount 232.

A status field 234 shows the status of the request and the date the request was received 236. The staff person 238 processing the request is identified. Upon completion, a completion date 240 is entered and forwarding information 242 is supplied as appropriate. In this way, the request for reimbursement can be tracked as it is processed.

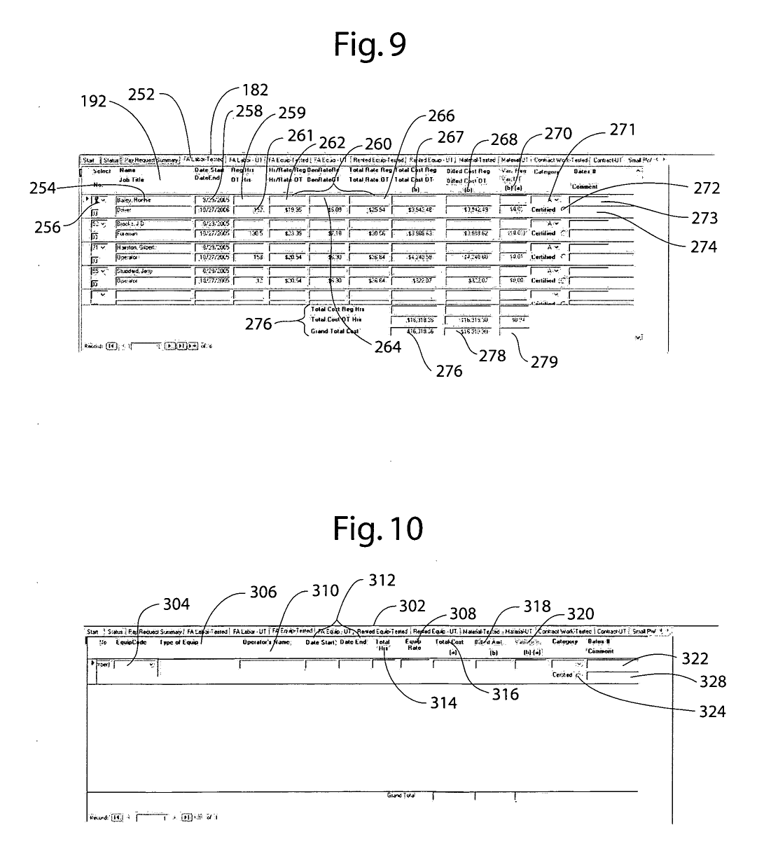

By activating the force labor tested button 182, a force labor tested screen 252 will be presented, as illustrated in FIG. 9. The screen 252 includes the name and job title 254 of each person providing labor for the project. A drop-down list accessible through a select button 256 enables populating personnel information as shown in FIG. 10. The labor data includes the starting and end date 258 of the labor activity, the regular hours 259 and overtime hours 261 to be included in the requested reimbursement cost. Rate fields generally 260 are provided for entry of regular and overtime rates 262, cost of benefits rates 264, and a total rate 266. A total cost field 267 is determined by multiplying the hours 259, 261 by the appropriate total rate 266. A billed cost regular and overtime field 268 receives the amount that the applicant is requesting for reimbursement. A variance field 270 automatically shows variances between the requested regular time and overtime reimbursements in the computed cost. A category of expense 271 identifies the nature of the labor for which reimbursement is sought. FEMA defines a number of categories that identify the type of project, for example, debris removal, temporary or interim repairs made to protect the damaged property, approved projects for repair or reconstruction, and other such categories. If the source document providing the information as to the labor costs is approved such as by a signature, a certified box 272 is activated. A tracking field 273 receives a document number or other tracking number assigned to the document. A comments field 274 permits entry of a comment regarding the particular employee. A separate record is made for each labor personnel for which cost reimbursement is sought. The screen 192 includes total fields generally 276 for the computed labor cost, the billed labor cost 278 and the variance 279.

As discussed above, untested expenses can be submitted, if the grantee will reimburse such submitted costs. The system includes a separate data screen (not illustrated) for entry of labor cost expenses which are untested. This data screen includes the same data fields as shown in FIG. 9, except for the hours 259, 261, the rates information 260, and the variance information.

FIG. 10 illustrates a data screen 302 for force applied equipment tested for entry of costs on force equipment as submitted by the applicant. This information includes the equipment code 304 and the type of equipment 306. The data field for the equipment code 304 includes a drop-down list having the equipment code, the description of the equipment, and an equipment rate. The description and the rate automatically populate the type of equipment 306 and the equipment rate 308 upon selection of the equipment from the drop down list. Using the submitted reimbursement request document, the operator name 310 and start/end dates 312 entered with the total hours 314. A total cost 316 is computed by using the total hours 314 and the equipment rate 308. The billed amount 318 is entered from the supporting documentation and a variance 320 is determined. The record further includes the category 322 (either through direct entry or by drop down list) certification 324 if the applicants document is indicated as having been certified or approved by appropriate personnel as well as a document number 326 and comments 328.

A data screen (not illustrated) similar to that shown in FIG. 10 provides entry and searching of invoices for equipment (untested), without the variance analysis fields discussed above.

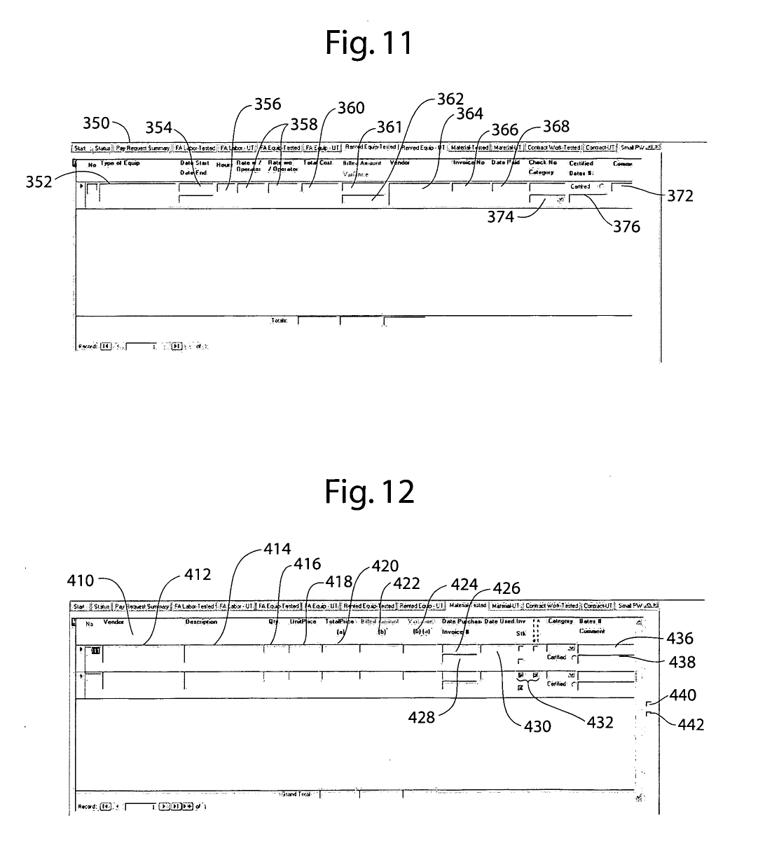

FIG. 11 illustrates the screen 350 for entry (or search of) support information as to rented equipment tested for which reimbursement is sought. The detailed information includes the type of equipment 252, start and end dates 354, total hours used 356 as indicated by the supporting documentation such as equipment log, time sheets, or other documents. Rate fields 358 (with and without operator) are used to calculate the total cost 360. A variance field 362 shows the billed amount 361 and the difference between the billed amount and the total cost 360. Vendor information is entered including the vendor name 364, vendor invoice 366, date paid 368 reflecting the date the applicant paid the vendor. The category field 370 is populated through direct entry or drop down lists, certification 372 is indicated together with the document number 374 and comments 376.

A data screen (not illustrated) similar to that shown in FIG. 11 provides for entry and searching of documentation for rented equipment (untested), without the variance analysis discussed above.

FIG. 12 illustrates a data screen 410 for material-tested expenses for entry of detailed or summarized information on material purchases including meals, gas, and other reimbursable items. The record includes the vendor name 412, item description 414, quantity 416, and unit price 418. A total cost 420 is computed using the quantity 416 and unit price 418. The billed amount 422 is compared to the computed amount 420 and a variance 424 determined. The record includes the date purchased 426, vendor invoice number 428 and the date the material was used 430, the material indication 432 (inventory or stock, or as appropriate) and whether the material is a fixed asset requiring accounting and tracking. The category 436, certification 438, document number 440, and comments 442 are entered.

A data screen (not illustrated) similar to that shown in FIG. 12 provides for entry of and searching of documentation for materials (untested) for entering material purchases which are not subject to testing prior to reimbursement, without the variance information discussed above.

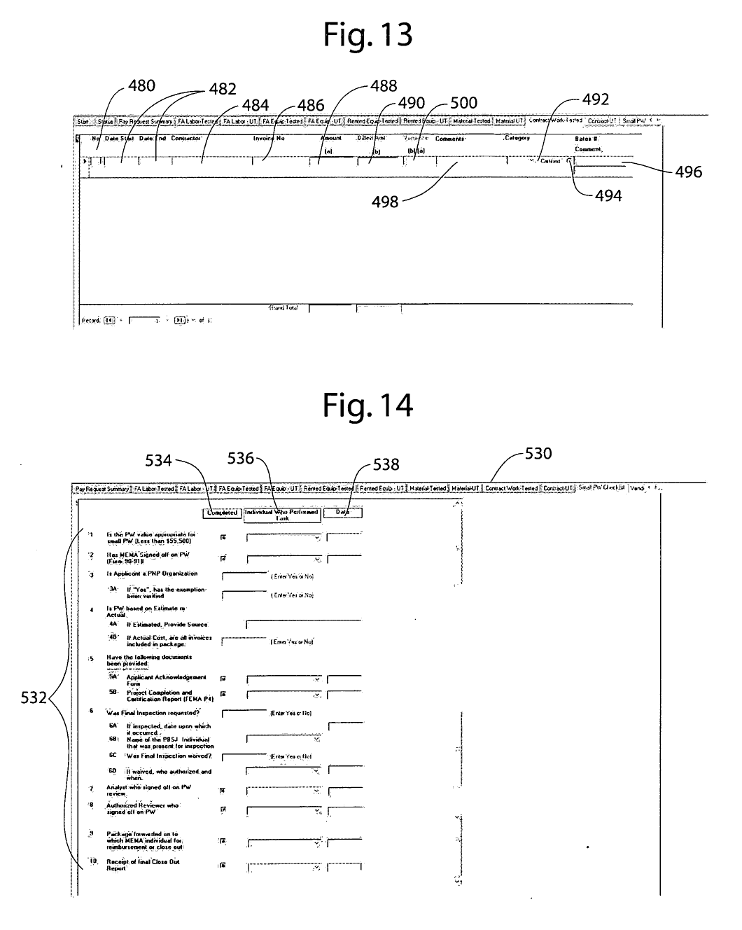

FIG. 13 illustrates a data screen 480 for contract work tested for entering detailed or summarized information on work performed by standing contracts or bid contracts. This includes the start and end date 482, the contractor 484 who performed the work, the invoice number 486, the invoice amount 488, the requested reimbursement amount 490, category 492, certification 494, document number 496 and comments 498. A variance 500 is determined by the difference between the billed amount 490 and the invoice amount 488.

A data screen (not illustrated) similar to that shown in FIG. 13 provides for entry of and searching of documentation for contract work (untested) except for the variance information.

FIG. 14 illustrates a close-out screen 530 for closing out small work projects. The check list screen for project close-out 530 includes a list of activities generally 532, a completion button 534, a performing individual 536, and date 538. The person indicated in the performing name 536 checks the completion box 534 when the particular activity 532 is completed. The activities 532 depend on the requirements of the granting agency. The illustrated embodiment, ten activities with sub-parts were required to be completed before reimbursement could be authorized.

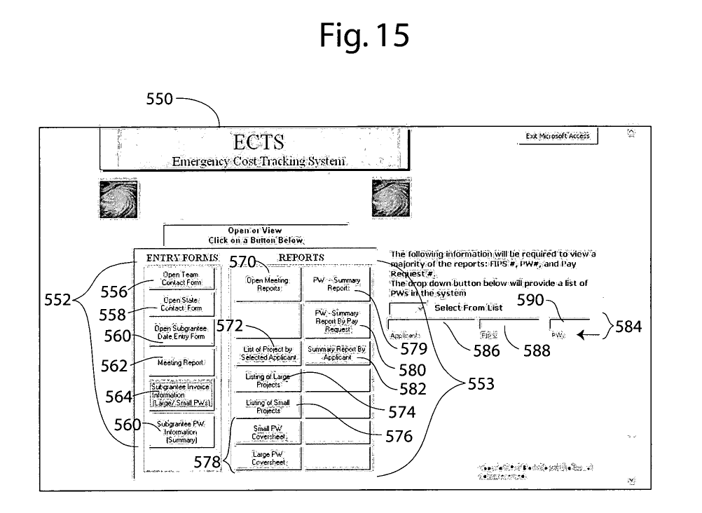

FIG. 15 illustrates a control screen 550 for selectively accessing data screens generally 552 and report screens 554. The data screens 552 include buttons for accessing the team contact form shown 556 in screen 3 and discussed above; state contact or grantee form 558 discussed above with respect to FIG. 3; sub-grantee data entry form 560 for accessing the data screen 76 for sub-grantee data as discussed above in reference to FIG. 4; meeting report 562 for accessing the meeting report screen 136 discussed above with reference to FIG. 7; sub-grantee invoice information 564 for accessing the data screen 170 discussed above in reference to FIG. 8; and summary projects information 566. In addition, reports can be directly accessed including meeting reports 570, projects by selected applicant 572, large projects 574, small projects 576, cover sheet documents 578, summary reports by project 579, summary reports by pay requests 580 and summary report by applicant 582. In addition, reports often are useful by selecting according to the emergency number assigned to the emergency, project number, or pay request number. A drop-down menu field 584 enables selecting particular emergencies 586, projects 588, or applicants pay requests 590 using drop-down windows for selecting particular ones of these.

The emergency cost tracking and reporting apparatus operates to receive information from public and nonprofit entities affected by the emergency for which reimbursement of reconstruction costs can be obtained from state and federal agencies upon submission of required documentation of the costs. With reference to FIG. 2, upon declaration of an emergency, appropriate confirming agencies invoke emergency procedures 39. An emergency identification number is created and associated with a particular named emergency. With reference to FIG. 1, sub-grantees may apply for reimbursement of reconstruction costs in response to the emergency. Information about projects for reconstruction reimbursement can be made online through the communications network or in person at specially arranged facilities staffed by team members. Each team member is registered with the system using the team contact screen 50 shown in FIG. 3. A similar data screen provides entry for agency contact information. Each sub-grantee submits contact information for entry on data screen 76 shown in FIG. 4. FIG. 4 further includes project information associated with the sub-grantee for which reimbursement of reconstruction costs is requested.

With reference to FIG. 4, each applicant provides project information for which reimbursement is sought. The project ID, disaster number and disaster name are entered, such as by using the drop-down menu screen. The pay request sequence number 174 is entered. Using the selection buttons for categories of expenses, labor force 182, force equipment 184, rented equipment 186, material 188 and contracts 190 can be entered for both tested and untested expenses using the data screens described above.

Although not illustrated, original source documents are readily scanned into to the system using a conventional scanner. Any such scanned documents are maintained in the system and are trackable by disaster number 82, applicant 88, project number 94, and the like criteria. Maintaining a scanned copy of the supporting documentation facilitates audit compliance to the extent necessary in future years.

The present apparatus provides real time analysis of the status of submitted requests for reimbursement of reconstruction costs. The grantee can track information by sub-grantee and by project. Particular contractors can be evaluated across the various projects on which they are engaged. Sub-grantees concerned about future audits can discuss with the team member the status of requests for reimbursement. Based on the testing ratio and the quality ratio, reimbursement can be made with increased confidence in meeting the grantees requirements for reimbursement and containing sufficient information to satisfy audit inquiries. Particularly, requests for reimbursement that are tested include a field indicating whether the requested costs were supported with certified documentation. A percentage of the tested reimbursement costs meeting the certification requirement can be generated. Each grantee can determine a quality value for the tested data on which to authorize reimbursement. The grantee may authorize payment if the tested request for reimbursement is supported by certified documentation at a pre-selected threshold. For example, the grantee may pay reimbursement based on 80% compliance of certified documents on the tested percentage. The tested percentage may vary between zero (0) or no testing and 100% testing. If the grantees threshold is 70% quality, then at least 70% of the tested percentage must be satisfied with certified receipts, invoices, documents and the like. Otherwise, the quality of the request for reimbursement is insufficient and the request is denied. By having access to such analysis information, the team member involved with the sub-grantee can readily advise the sub-grantee as to the status of the request for reimbursement and what additional documents are necessary in order for the reimbursement to occur.

With reference to FIG. 15, various reports are selectively available, and a report generator accesses the database to select and filter information for reports using as access criteria a selection fact to be searched in the database for reporting. A project cover sheet includes the emergency identification, the applicant or sub-grantee, and project. A check list itemizes the documents including the request for public assistance, the proof of eligibility, the project worksheet (labor, equipment, rental, materials, and contract), completion certificates, inspections, and approval, as well as payment information. A project summary report includes on project basis, the labor, equipment, rental, materials, and contract expenses billed, allowed, and documented. The tested amounts are also displayed, together with the project budget amount and the remaining expenditures for the project to completion. A summary report by pay request details the expenses and costs included in a particular pay request, including relevant dates of the request and the payment, itemizations of expenses (tested and untested) as to billed, documented and verified or certified amounts, variances, and repayment risk amounts. Summary reports by emergency or by grantee can be generated, listing sub-grantee and or projects, including location, amount billed, reviewed, supported or certified, and variances.

It is to be appreciated that the emergency recovery costs and disbursements tracking and reporting system described herein in an illustrative embodiment likewise finds gainful application for insurance carriers having policies covering private and public facilities within the damage area involved in the emergency, in which the insurance carrier has responsibility for verifying damage, approving proposed repair and reconstruction projects, tracking project costs, and disbursing of funds in payment for damages and reconstruction costs upon submission of adequate documentation by the insured, or with early projection of project costs and expenses to completion, insured settlements can be negotiated promptly. Further, the emergency recovery costs and disbursements tracking and reporting system provides flexible and selectable analysis of the emergency damages and reconstruction based on user-specified criteria for searching and filtering of information maintained on the database, including specific location, building, or infrastructure, vendor, project, contractor, grantee, sub-grantee, equipment usage, materials, and labor, with the associated emergency damages, deductibles, costs, and reimbursements paid to the sub-grantee. Appropriate and timely reimbursements of costs are facilitated while double payments are reduced.

The system of the present invention readily operates on conventional personal computers and world wide network interconnections between the system operator, the grantees and the subgrantees, for example with a MICROSOFT SQL server application storing the database and informational tables with an interrogator software application such as MICROSOFT ACCESS software providing a front end application for user interface to the database. The system performs financial oversight of emergency recovery events including itemization, tracking, review and reporting of reconstruction costs, within federal and state requirements and functionality as well as reporting for unusual or specific transactions. Emergency events can be tracked a both a summary and detailed level with analysis of data submitted in support of reimbursable expenses and costs, with customized reports for management engaged in administration and control of emergency recovery events.

This specification has described the preferred embodiments of the present invention for the tracking and reporting of emergency recovery costs and disbursements of finds in payment of those costs including the apparatus and method in various aspects of the invention. It is to be understood, however, that numerous changes and variations may be made in the construction of the present container within the spirit and scope of the present invention. It should therefore also be understood that the foregoing specification relates only to the preferred embodiments of the present invention and that modifications and changes may be made therein without departing from the scope thereof as set forth in the appended claims.

What is claimed is:

1. An apparatus for tracking and reporting of emergency recovery costs and disbursements of funds in payment thereof, comprising:
a central computer having a database of a plurality of applicants for emergency recovery funds to be applied in payment of recovery costs, each of the applicants having at least one project for recovery from an emergency and for which a payment of recovery costs is selectively funded from a supply of emergency recovery funds;
means for each of the applicants to apply for payment of recovery costs associated with at least one project;
means for receiving and storing for analysis access at least one submitted document reflecting a recovery cost submitted for payment and at least one support document justifying funding of payment of the recovery cost;
an analyzer configured for evaluating submitted recovery costs and support documents and determining a payment authorization factor; an
a payment center for funding payment of the recovery costs based on the payment authorization factor.

2. The apparatus as recited in claim 1, further comprising an reporter configured for interrogating the database as to at least one selected access criteria in order to report to an inquirer as to information maintained in the database.

3. The apparatus as recited in claim 1, further comprising at least one computerized interaction device remote from the central computer and configured for communicating with the database for supplying the database with applicant information, project information, submitted recovery cost information, support documents, and payment information.

4. The apparatus as recited in claim 1, further comprising a payment criteria on which the payment authorization factor is based.

5. The apparatus as recited in claim 4, wherein the payment criteria comprises a tested percentage ranging from 0% to 100%, which percentage of expense items must be supported with certified documents.

6. The apparatus as recited in claim 5, wherein the expense items include force labor, force equipment, rentals, materials, and contract.

7. The apparatus as recited in claim 5, wherein the payment criteria further comprises a threshold percentage of the tested percentage which must be documented in order for the payment authorization to be granted.

8. A method for tracking and reporting of emergency recovery costs and disbursements of funds in payment thereof, comprising the steps of:
(a) providing to a database of a central computer information as to a plurality of applicants for emergency recovery funds to be applied in payment of recovery costs, each of the applicants having at least one project for recovery from an emergency and for which a payment of recovery costs is selectively funded from a supply of emergency recovery funds;
(b) identifying at least one project associated with at least one of the applicants seeking payment of recovery costs associated with at the project;
(c) receiving and storing for analysis access at least one submitted document reflecting a recovery cost submitted for payment and at least one support document justifying funding of payment of the recovery cost;
(d) analyzing the submitted recovery costs and the support documents to determine a payment authorization factor; and
(e) selectively funding payment of the recovery cost based on the payment authorization factor.

9. The method as recited in claim 8, wherein the step of analyzing the subjected recovery costs and support documents comprises the steps of:
providing a tested percentage corresponding to the percentage of funds that must be supported by documentation in order for the payment authorization to be approved; and
comparing the percentage of expenses for reimbursement against a total project cost to the tested percentage.

10. The method as recited in claim 9, further comprising the steps of:
providing a threshold percentage corresponding to the percentage of tested expenses that must be supported by documentation in order for the payment authorization to be approved; and
comparing the threshold percentage of tested expenses for reimbursement against a total tested expenses for the project cost.

11. A computerized apparatus for tracking, analysis, and reporting of emergency recovery costs and disbursements of funds in payment thereof, comprising:
a computerized coordinator having an information database of a plurality of applicants for emergency recovery funds to be applied in payment of recovery costs, each of the applicants having at least one project for recovery from an emergency and for which a payment of at least one recovery cost is selectively funded from a supply of emergency recovery funds;
an application interface for each of the applicants to provide to the database recovery cost information based on at least one support document reflecting a recovery cost for reimbursement in application for payment of recovery costs associated with the project;
an analyzer configured for evaluating submitted recovery costs and support documents and determining a payment authorization factor; and
a payment center for funding payment of the recovery costs based on the payment authorization factor.

12. The apparatus as recited in claim 11, further comprising a reporter configured for interrogating the database as to at least one selected access criteria in order to report to an inquirer as to information maintained in the database.

13. The apparatus as recited in claim 12, wherein the access criteria comprises a selection fact to be searched in the database for reporting.

14. The apparatus as recited in claim 13, wherein the selection fact is selected from the group consisting of labor, equipment, rental, materials, and contract.
